(19) United States
(12) Patent Application Publication
(10) Pub. No.: US 2007/0270191 A1
(43) Pub. Date: Nov. 22, 2007

(54) PORTABLE COMMUNICATION DEVICE AND METHOD FOR CONSERVING POWER

(75) Inventors: Han-Che Wang, Shenzhen City (CN); Hsin-Nan Hu, Shenzhen City (CN); Kuan-Hong Hsieh, Shenzhen City (CN); Xiao-Guang Li, Shenzhen City (CN)

Correspondence Address: NORTH AMERICA INTELLECTUAL PROPERTY CORPORATION, P.O. BOX 506, MERRIFIELD, VA, 22116, US

(73) Assignees: ENSKY TECHNOLOGY (SHENZHEN) CO., LTD., Shenzhen City (CN); ENSKY TECHNOLOGY CO., LTD., Taipei Hsien (TW)

(21) Appl. No.: 11/750,343

(22) Filed: May 18, 2007

(30) Foreign Application Priority Data
May 19, 2006 (CN) 200610060722.1

(51) Int. Cl. H04B 1/38

(52) U.S. Cl. 455/574

(57) ABSTRACT

An exemplary method for conserving power of a portable communication device includes supplying voltage by a power supply of the portable communication device; distributing one or more corresponding voltages to other components; the portable communication device entering a normal mode and enabling user-selected prompts after being powered by one of said voltages; generating digital voltage signals corresponding to the voltage supplied by the power supply; detecting a voltage of the digital voltage signals to obtain a detected voltage; comparing the detected voltage with a predetermined value; changing a current mode of the portable communication device from the normal mode to a power conserving mode, if the detected voltage is equal to or less than the predetermined value and the current mode is the normal mode; and disabling a pickup button of the portable communication device. Thereby, an operational time of other units of the portable communication device can be prolonged.

### CROSS REFERENCE TO RELATED APPLICATION

This application is related to a commonly-assigned pending application filed concurrently herewith and also entitled “PORTABLE COMMUNICATION DEVICE AND METHOD FOR CONSERVING POWER”. Disclosure of the above identified application is incorporated herein by reference.

### BACKGROUND OF THE INVENTION

1. Field of the Invention

The present invention relates to portable communication devices and methods for conserving power of portable communication devices, and especially to a portable communication device and a method involving disabling of a unit of the portable communication device and thereby prolonging an operational time of other units of the portable communication device.

2. Description of Related Art

In the so-called “information age”, portable communication devices have become more and more important in people's lives. Portable communication devices include mobile phones, personal digital assistants (PDAs), and other similar devices.

A typical portable communication device is supplied with voltage by a battery. Because the capacity of the battery is limited, when the voltage of the battery is below a certain value, the portable communication device becomes unusable.

A common type of PDA available in the market includes a communication unit. The communication unit can be disabled by a user independently of other functional units of the PDA. Thus, an operational time of the other functional units of the PDA can be prolonged. In detail, the PDA has a so-called flight mode. If the user selects the flight mode, the PDA restarts and disables the communication unit. After the communication unit of the PDA is disabled, the PDA can still be used to perform other functions, such as searching desired contact information in an address list, playing games, and so on. However, when the communication unit of the PDA is disabled, the PDA can no longer receive communication signals, so it is possible for the user to miss important incoming calls and text messages.

Therefore, a heretofore unaddressed need exists in the industry to overcome the aforementioned deficiencies and inadequacies.

### SUMMARY OF THE INVENTION

A portable communication device and a method for conserving power of a portable communication device are provided. The portable communication device automatically disables a pickup button if voltage of the portable communication device is equal to or less than a predetermined value, thereby prolonging an operational time of the portable communication device.

The portable communication device includes a storage unit, a power supply, a power management unit, an analog-to-digital converter, a pickup button and central processing unit. The storage unit is configured for storing user-selected prompts. The pickup button is configured for sending outgoing calls and answering incoming calls. The power supply supplies voltage to the power management unit and the analog-to-digital converter. The power management unit distributes one or more corresponding voltages to one or more components of the portable communication device. The analog-to-digital converter generates digital voltage signals corresponding to the voltage supplied by the power supply. The central processing unit includes a controlling module and a detection module. The controlling module signals the portable communication device to enter a normal mode after being powered by a voltage of the central processing unit, and enables the user-selected prompts stored in the storage unit. The detection module receives the digital voltage signals from the analog-to-digital converter, detects a voltage of the digital voltage signals to obtain a detected voltage, and compares the detected voltage with a predetermined value. If the detected voltage is equal to or less than the predetermined value, the controlling module signals the portable communication device to change from the normal mode to a power conserving mode. When the portable communication device changes from the normal mode to the power conserving mode, the controlling module disables the pickup button when the portable communication device changes from the normal mode to the power conserving mode.

Other systems, methods, features, and advantages will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

FIG. 1 is a front view of a mobile phone in accordance with an exemplary embodiment of the present invention.

FIG. 2 is a block diagram of hardware infrastructure of the mobile phone of FIG. 1.

FIG. 3 is a flowchart of an exemplary method for conserving power of the mobile phone of FIG. 1.

### DETAILED DESCRIPTION OF THE INVENTION

The present features and functions involving conserving power can be incorporated in a portable communication device such as a mobile phone or a personal digital assistant (PDA). The following detailed description of exemplary and preferred embodiments is made with reference to the attached drawings.

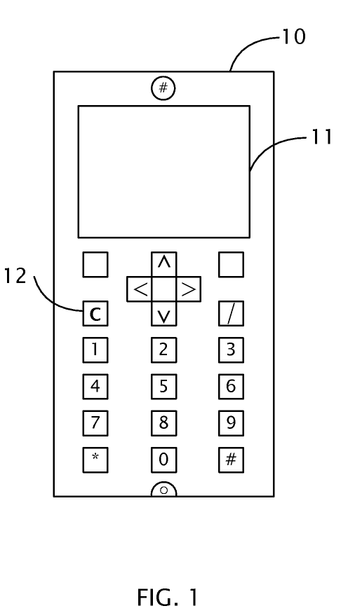

FIG. 1 is a front view of a mobile phone 10 in accordance with an exemplary embodiment of the present invention. The mobile phone 10 includes a display panel 11 and a keypad. The keypad includes a plurality of function keys and alphanumerical keys for a user to enter operational inputs (instructions). The function keys include a pickup button 12. The pickup button 12 is configured for sending outgoing calls and answering incoming calls. The display panel 11 is configured for displaying information of the mobile phone 10. The information includes incoming calls, text messages, an address list, and so on.

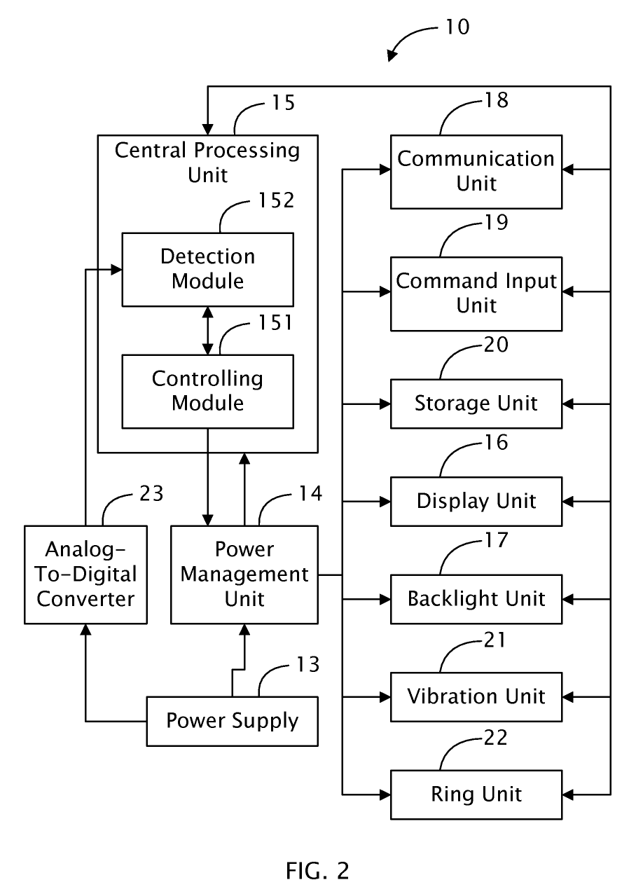

FIG. 2 is a block diagram of hardware infrastructure of the mobile phone 10. In this aspect, the mobile phone 10 includes a power supply 13, a power management unit 14, a central processing unit 15, a display unit 16, a backlight unit 17, a communication unit 18, a command input unit 19, a storage unit 20, a vibration unit 21, and a ring unit 22.

The power supply 13 may be a nickel-cadmium battery, a lithium-ion battery, or another suitable kind of secondary cell. The power supply 13 is configured for connecting to the power management unit 14, and supplying a voltage to the power management unit 14. The power management unit 14 receives the voltage from the power supply 13, and distributes corresponding voltages to various components of the mobile phone 10. The components include the central processing unit 15, the display unit 16, the backlight unit 17, the communication unit 18, the command input unit 19, the storage unit 20, the vibration unit 21, and the ring unit 22.

The display unit 16 is configured for displaying information on the display panel 11. The information may include incoming calls, text messages, an address list, and so on. The backlight unit 17 is configured for illuminating the display panel 11. After an operational instruction is input on the command input unit 19 by the user, the command input unit 19 can process the instruction accordingly. In particular, the command input unit 19 is configured for generating a corresponding command instruction, and sending the command instruction to the central processing unit 15. For example, when the portable communication device is receiving an incoming call and the pickup button 12 is pressed by the user, the corresponding operational instruction is entered in the command input unit 19. Accordingly, the command input unit 19 generates an answer instruction so as to answer the incoming call.

The communication unit 18 is configured for performing communication functions of the mobile phone 10. That is, the communication unit 18 receives and/or transmits communication signals via wireless communication means, and as a result the mobile phone 10 is able to communicate with other communication devices (not shown).

When the mobile phone 10 receives an incoming call or a text message, the central processing unit 15 signals the vibration unit 21 and/or the ring unit 22 to vibrate and/or ring respectively, so as to alert the user.

The storage unit 20 stores the address list, the text messages, user-selected prompts, power conserving options, and a predetermined text message. The user-selected prompts include at least one of the choices of turning on the backlight unit 17, enabling the vibration unit 21, and enabling the ring unit 22. While the mobile phone 10 is receiving an incoming call or a text message, the user-selected prompts are enabled in order to alert the user. The power conserving options include at least one of the choices of disabling the backlight unit 17, disabling the vibration unit 21, and disabling the ring unit 22. The predetermined text message is configured for messaging the caller that the recipient will call back later. For example, the message can be “my cellphone out of power, I will call back later”.

Modes of the mobile phone 10 include a normal mode and a power conserving mode. In the normal mode, the mobile phone 10 can perform all its normal functions. The normal functions include enabling the user-selected prompts, receiving incoming calls, dialing a telephone number, searching contact information, voice dialing or voice alerting, and so on. In the power conserving mode, the pickup button 12 of the mobile phone 10 is disabled, and the selected power conserving options are enabled. Thereby, the mobile phone 10 cannot receive incoming calls and cannot provide dialing of a telephone number. Further, in the power conserving mode, at least one of the following options is in effect: the backlight unit 17 is turned off, the vibration unit 21 is disabled, and the ring unit 22 is disabled.

The mobile phone 10 further includes an analog-to-digital converter 23. When the mobile phone 10 is powered on, the power supply 13 supplies a voltage to the analog-to-digital converter 23. The analog-to-digital converter 23 receives the voltage, converts the voltage to digital voltage signals, and sends the digital voltage signals to the central processing unit 15.

The central processing unit 15 includes a controlling module 151 and a detection module 152. The controlling module 151 signals the mobile phone 10 to enter the normal mode after being powered by the voltage of the central processing unit, and enables the user-selected prompts.

The detection module 152 receives the digital voltage signals from the analog-to-digital converter 23, detects a voltage of the digital voltage signals to obtain a detected voltage, and compares the detected voltage with a predetermined value. The predetermined value is a threshold amount of remaining voltage of the power supply 13. When the detected voltage is less than the predetermined value, this means the remaining voltage of the power supply 13 is low. Accordingly, usage of the mobile phone 10 should be limited. For example, such usage is restricted to performing only certain functions, such as searching desired contact information in the address list if necessary. Thus, the detection module 152 conveys the result of the comparison of the detected voltage with the predetermined value to the controlling module 151. At this time, the controlling module 151 detects a current mode of the mobile phone 10.

If the detected voltage is equal to or less than the predetermined value and the mobile phone 10 is in the power conserving mode, the controlling module 151 does not signal the mobile phone 10 to change the current mode. However, if the mobile phone 10 is in the normal mode, the controlling module 151 signals the mobile phone 10 to change from the normal mode to the power conserving mode, disables the pickup button 12, and enables the power conserving options stored in the storage unit 20.

If the detected voltage is greater than the predetermined value, and the mobile phone 10 is in the normal mode, the controlling module 151 does not signal the mobile phone 10 to change the current mode. However, if the mobile phone 10 is in the power conserving mode, the controlling module 151 enables the pickup button 12 and the user-selected prompts, and signals the mobile phone 10 to change from the power conserving mode to the normal mode.

Furthermore, in the power conserving mode, when the mobile phone 10 receives an incoming call from a caller, the controlling module 151 identifies a telephone number of the incoming call. That is, the controlling module 151 detects whether the telephone number of the incoming call is from a telecommunication provider that provides text message services.

If the controlling module 151 identifies that the telephone number of the incoming call is from a telecommunication provider that provides text message services, the controlling module 151 records the telephone number of the incoming call to the storage unit 20, and automatically transmits the predetermined text message to the caller.

If the controlling module 151 identifies that the telephone number of the incoming call is not from a telecommunication provider that provides text messages, the controlling module 151 only records the telephone number of the incoming call to the storage unit 20.

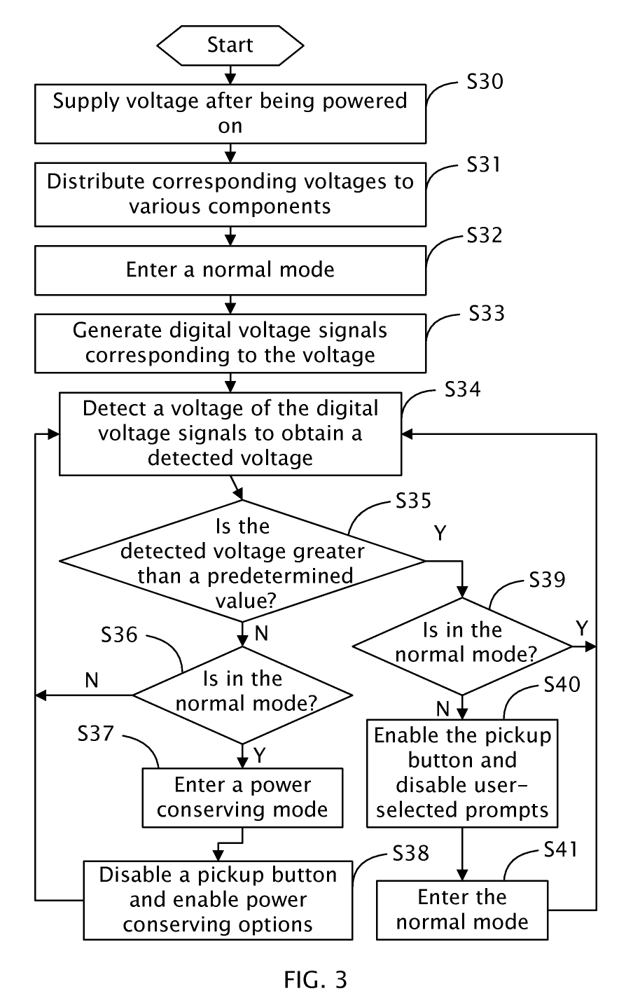

FIG. 3 is a flowchart of an exemplary method for conserving power of the mobile phone 10. In step S30, when the mobile phone 10 is powered on, the power supply 13 supplies voltage to the power management unit 14 and the analog-to-digital converter 23.

In step S31, the power management unit 14 distributes corresponding voltages to various components of the mobile phone 10.

In step S32, the controlling module 151 signals the mobile phone 10 to enter the normal mode after being powered by the corresponding voltage of the central processing unit 15.

In step S33, the analog-to-digital converter 23 receives the voltage from the power supply 13, and generates digital voltage signals corresponding to the voltage.

In step S34, the detection module 152 receives the digital voltage signals, and detects a voltage of the digital voltage signals to obtain a detected voltage.

In step S35, the detection module 152 compares the detected voltage with the predetermined value, and determines whether the detected voltage is greater than the predetermined value.

If in step S35 the detected voltage is equal to or less than the predetermined value, then in step S36, the controlling module 151 detects a current mode of the mobile phone 10.

If the mobile phone 10 is in the power conserving mode, the controlling module 151 does not signal the mobile phone 10 to change the current mode, and the procedure goes back to step S34. If the mobile phone 10 is in the normal mode, in step S37, the controlling module 151 signals the mobile phone 10 to change from the normal mode to the power conserving mode, whereupon the procedure goes to step S38.

In step S38, the controlling module 151 disables the pickup button 12 and enables the power conserving options, whereupon the procedure goes back to step S34. In an alternative embodiment, the controlling module 151 can disable the pickup button 12, with the power conserving options not being enabled.

If in step S35 the detected voltage is greater than the predetermined value, then in step S39, the controlling module 151 detects a current mode of the mobile phone 10.

If the mobile phone 10 is in the normal mode, the procedure goes back to step S34. If the mobile phone 10 is in the power conserving mode, in step S40, the controlling module 151 enables the pickup button 12 and the user-selected prompts stored in the storage unit 20, whereupon the procedure goes to step S41. In an alternative embodiment of step S40, the controlling module 151 only enables the pickup button 12, with the user-selected prompts already being enabled.

In step S41, the controlling module 151 signals the mobile phone 10 to change from the power conserving mode to the normal mode, whereupon the procedure goes back to step S34. Steps S34 to S41 are then performed iteratively if and as necessary until the mobile phone 10 is powered off.

It is understood that the invention may be embodied in various other forms without departing from the spirit thereof. Thus, the present examples and embodiments are to be considered in all respects as illustrative and not restrictive, and the invention is not to be limited to the details given above.

What is claimed is:

1. A portable communication device able to conserve power, the portable communication device comprising:
a storage unit configured for storing user-selected prompts;
a pickup button configured for sending outgoing calls and answering incoming calls;
a power supply configured for supplying voltage;
a power management unit configured for receiving the voltage from the power supply, and distributing one or more corresponding voltages to other components of the portable communication device;
an analog-to-digital converter configured for receiving the voltage from the power supply, and generating digital voltage signals corresponding to the voltage; and
a central processing unit comprising:
a controlling module for signaling the portable communication device to enter a normal mode after being powered by a voltage of the central processing unit, and enabling the user-selected prompts; and
a detection module for receiving the digital voltage signals from the analog-to-digital converter, detecting a voltage of the digital voltage signals to obtain a detected voltage, and comparing the detected voltage with a predetermined value;
wherein if the detected voltage is equal to or less than the predetermined value and a current mode of the portable communication device is the normal mode, the controlling module signals the portable communication device to change from the normal mode to a power conserving mode; when the portable communication device changes from the normal mode to the power conserving mode, the controlling module disables the pickup button.

2. The portable communication device according to claim 1, wherein if the detected voltage is greater than the predetermined value and the current mode of the portable communication device is the normal mode, the controlling module does not signal the portable communication device to change the current mode.

3. The portable communication device according to claim 1, wherein if the detected voltage is greater than the predetermined value and the current mode of the portable communication device is the power conserving mode, the controlling module enables the pickup button and any of the user-selected prompts that are disabled, and signals the portable communication device to change from the power conserving mode to the normal mode.

4. The portable communication device according to claim 1, further comprising a backlight unit, a vibration unit, and a ring unit, wherein the user-selected prompts comprises at least one of turning on the backlight unit, enabling the vibration unit, and enabling the ring unit, and when the portable communication device changes from the normal mode to the power conserving mode, the controlling module also disables at least one of the user-selected prompts.

5. The portable communication device according to claim 1, wherein the storage unit is configured for storing power conserving options, and when the portable communication device changes from the normal mode to the power conserving mode, the controlling module also enables the power conserving options.

6. The portable communication device according to claim 5, further comprising a backlight unit, a vibration unit, and a ring unit, wherein the power conserving options comprises at least one of turning off the backlight unit, disabling the vibration unit, and disabling the ring unit.

7. The portable communication device according to claim 1, wherein if the detected voltage is equal to or less than the predetermined value and the current mode of the portable communication device is the power conserving mode, the controlling module does not signal the portable communication device to change the current mode.

8. The portable communication device according to claim 1, wherein the storage unit is further configured for storing a predetermined text message for messaging an incoming caller that a user of the portable communication device will call back later, and if the current mode of the portable communication device is the power conserving mode and the portable communication device receives an incoming call from a caller, the controlling module detects whether the incoming call is from a telecommunication provider that provides text message services, and if the incoming call is from a telecommunication provider that provides text message services, the controlling module sends the predetermined text message to the caller.

9. A method for conserving power of a portable communication device, the method comprising:
supplying voltage by a power supply of the portable communication device;
distributing one or more corresponding voltages to other components of the portable communication device;
the portable communication device entering a normal mode and enabling user-selected prompts after being powered by one of said voltages;
generating digital voltage signals corresponding to the voltage supplied by the power supply;
detecting a voltage of the digital voltage signals to obtain a detected voltage;
comparing the detected voltage with a predetermined value; and
changing a current mode of the portable communication device from the normal mode to a power conserving mode, if the detected voltage is equal to or less than the predetermined value and the current mode is the normal mode; and
disabling a pickup button of the portable communication device, when the current mode of the portable communication device is changed to the power conserving mode.

10. The method according to claim 9, further comprising not signaling the portable communication device to change the current mode, if the detected voltage is greater than the predetermined value and the current mode is the normal mode.

11. The method according to claim 9, further comprising enabling the pickup button of the portable communication device, disabling any of the user-selected prompts, and changing from the power conserving mode to the normal mode, if the detected voltage is greater than the predetermined value and the current mode is the power conserving mode.

12. The method according to claim 9, wherein the portable communication device comprises a backlight unit, a vibration unit, and a ring unit, and the user-selected prompts comprise at least one of turning on the backlight unit, enabling the vibration unit and enabling the ring unit, and the method further comprises disabling at least one of the user-selected prompts when the current mode of the portable communication device is changed to the power conserving mode.

13. The method according to claim 9, further comprising enabling power conserving options when the current mode of the portable communication device is changed to the power conserving mode.

14. The method according to claim 13, wherein the portable communication device comprises a backlight unit, a vibration unit, and a ring unit, and the power conserving options comprise at least one of turning off the backlight unit, disabling the vibration unit, and disabling the ring unit.

15. The method according to claim 9, further comprising not signaling the portable communication device to change the current mode, if the detected voltage is equal to or less than the predetermined value and the current mode is the power conserving mode.

16. The method according to claim 9, further comprising detecting whether an incoming call to the portable communication device is from a telecommunication provider that provides text message services if the portable communication device receives the incoming call from a caller and the current mode is the power conserving mode, and sending a predetermined text message to the caller if the incoming call is from a telecommunication provider that provides text message services, wherein the predetermined text message advises the caller that a user of the portable communication device will call back later.
